(19) United States
(12) Patent Application Publication
(10) Pub. No.: US 2017/0344123 A1
(43) Pub. Date: Nov. 30, 2017

(54) Recognition of Pickup and Glance Gestures on Mobile Devices

(71) Applicant: Knowles Electronics, LLC, Itasca, IL (US)

(72) Inventor: Jagadish Venkataraman, San Jose, CA (US)

(21) Appl. No.: 15/169,605

(22) Filed: May 31, 2016

(51) Int. Cl. G06F 3/01; G06F 3/0346; G06F 3/038

(52) U.S. Cl. CPC G06F 3/017; G06F 3/0383; G06F 3/013; G06F 3/0346

(57) ABSTRACT

Methods and systems for recognition of pickup and glance gestures for a mobile device are provided. An example method includes acquiring sensor data generated by at least one sensor of a mobile device. Based on the sensor data, a particular transport mode associated with a motion of the mobile device may be determined. Based on the particular transport mode, a corresponding on/off body detector designed for the particular transport mode may be selected. The selected on/off body detector can be used to determine if the mobile device is located on or off a user's body. The example method includes, if the mobile device is determined to be on the user's body, analyzing the sensor data to detect a glance gesture. The example method also includes, if the mobile device is determined to be off the user's body, analyzing the sensor data to detect a pickup gesture.

### BACKGROUND

Mobile devices can be operated in different environments. For example, a user of the mobile device may walk, run, or travel in a car or other moving vehicle. During travel in a vehicle, for instance, the mobile device can experience vibrations due to vehicle operation and shake due to bumps in the road or due to sudden acceleration and deceleration of the moving vehicle. Moreover, mobile devices may be operated by people with different body tremor levels. For example, some people can experience more than typical trembling of hands. Each of these conditions can cause false gesture recognition by the mobile device, e.g., “false positives”. One typical gesture is a pickup gesture that can be associated with movement of the mobile device when the mobile device is picked up by a user from a desk, a pocket, a bag, a cup holder of a car, and the like. Another typical gesture is a glance gesture which is a specific motion of the mobile device that can be performed by a user while holding the mobile device in the user's hand and glancing at its screen. The above described conditions can cause false positives where a pickup/glance gesture is recognized by the device even though a pickup/glance has not occurred; and “false negatives” where a pickup/glance gesture is not recognized by the device even though a pickup/glance has occurred.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for recognition of a pickup and glance gestures for a mobile device are provided. Various embodiments of the systems and methods can substantially reduce or eliminate both false positives, where a pickup/glance gesture is recognized by the device even though a pickup/glance has not occurred, and “false negatives”, where a pickup/glance gesture is not recognized by the device even though a pickup/glance has occurred, which otherwise can occur, especially when a user of the mobile device is walking, running, biking, or travelling in a car or other moving vehicle.

According to an example embodiment, a method includes acquiring sensor data generated by at least one sensor of a mobile device. The method may also include determining, based on the sensor data, a particular transport mode associated with a motion of the mobile device. The particular transport mode is one of a plurality of transport modes, e.g. at rest, walking, in a moving vehicle, etc. The method may include selecting, based on the particular transport mode, a corresponding on/off body detector, of a plurality of on/off body detectors, that is associated with the particular transport mode. Each of the on/off body detectors can use a classifier designed for a corresponding transport mode and can be trained with other data collected when the mobile device is in the corresponding transport mode. The method may further include using the selected on/off body detector to determine if the mobile device is located on the body of a user or off the body of the user. If the mobile device is determined to be on the body of the user, the sensor data may be analyzed to detect a glance gesture. If the mobile device is determined to be off the body of the user, the method may include analyzing the sensor data to detect a pickup gesture.

According to another example embodiment of the present disclosure, the steps of the method for recognition of a pickup and glance gestures are stored on a machine-readable medium comprising instructions, which if implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram showing an example environment within which systems and methods of the present technology can be practiced.

FIG. 2 is a block diagram of an example mobile device which can be used to practice the present technology.

FIG. 3 is a block diagram illustrating a system including elements that can be used to practice methods of example embodiments of the present technology.

FIG. 4 is a block is a flow chart illustrating, at a high level, an example method for pickup and glance gesture recognition.

FIG. 5 is a block diagram showing an example system including elements operable to execute a method for pickup gesture recognition.

FIG. 6 is a block diagram showing an example system including elements operable to execute a method for glance gesture recognition.

FIG. 7 is a flow chart showing steps of an example method for recognition of pickup and glance gestures.

FIG. 8 is a computer system which can be used to implement example methods for recognition of pickup and glance gestures.

### DETAILED DESCRIPTION

The present disclosure provides example systems and methods for recognition of pickup and glance gestures performed on a mobile device. As used herein, “sensor data” can refer variously to raw data, processed data, and/or a representation of raw or processed data from one or more sensors. Embodiments of the present disclosure can be practiced, but not limited to, on various mobile devices, for example, a smart phone, a mobile phone, a tablet computer, a wearable (smart watch and/or smart glasses), and so forth. The mobile devices can be used in stationary and portable environments. The stationary environments can include residential and commercial buildings or structures, and the like. The portable environments can include moving persons, moving vehicles, various transportation means, and the like.

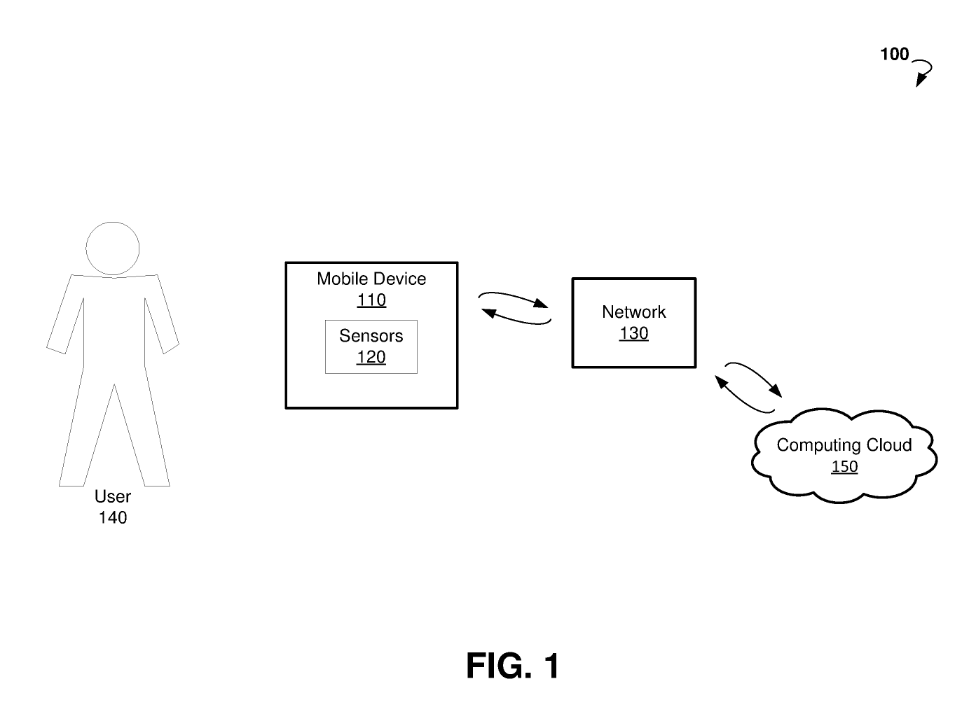

Referring now to FIG. 1, an example environment 100 for the recognition of the pickup and glance gestures, according to various embodiments, is shown. The recognition of user gestures, according to various embodiments, may be accomplished in an environment such as the example environment 100. The example environment 100 can include at least one mobile device 110. In various embodiments, the mobile device 110 can be associated with a user 140. For example, mobile device 110 associated with the user 140 can include a smart phone, a tablet computer, a smart watch, smart glasses, and so forth. The mobile device 110 can include sensors 120.

The sensors 120, in various embodiments, can include various sensors, including, but not limited to, motion sensors, inertial sensors, proximity sensors, and the like. For example, the sensors 120 can include an accelerometer. The sensors 120 may also include a magnetometer, a gyroscope, an Inertial Measurement Unit (IMU), an altitude sensor, a proximity sensor, and the like. In some embodiments, the sensors 120 includes at least one acoustic sensor, e.g., microphone. In some embodiments, the sensors 120 include sensors that can be used for determining positioning including Global Positioning System (GPS) positioning sensor element and Wi-Fi/cell tower sensor element.

In some embodiments, the mobile devices 110 are communicatively coupled to a cloud-based computing resource(s) 150 (also referred to as “computing cloud 150”). In some embodiments, the computing cloud 150 includes computing resources (hardware and software) available at a remote location and accessible over a network (for example, the Internet). The computing cloud 150 can be shared by multiple users and can be dynamically re-allocated based on demand. The computing cloud 150 can include one or more server farms/clusters including a collection of computer servers which can be co-located with network switches and/or routers. In various embodiments, the mobiles devices 110 are connected to the computing cloud 150 via one or more wired or wireless network(s) 130. The mobile devices 110 can be connected to network(s) 130 via Wi-Fi, Bluetooth, Near Field Communication (NFC), and the like. In some embodiments, the mobile devices 110 are operable to send data, for example sensor data, to computing cloud 150, request computational operations to be performed in the computing cloud, and receive back the results of the computational operations.

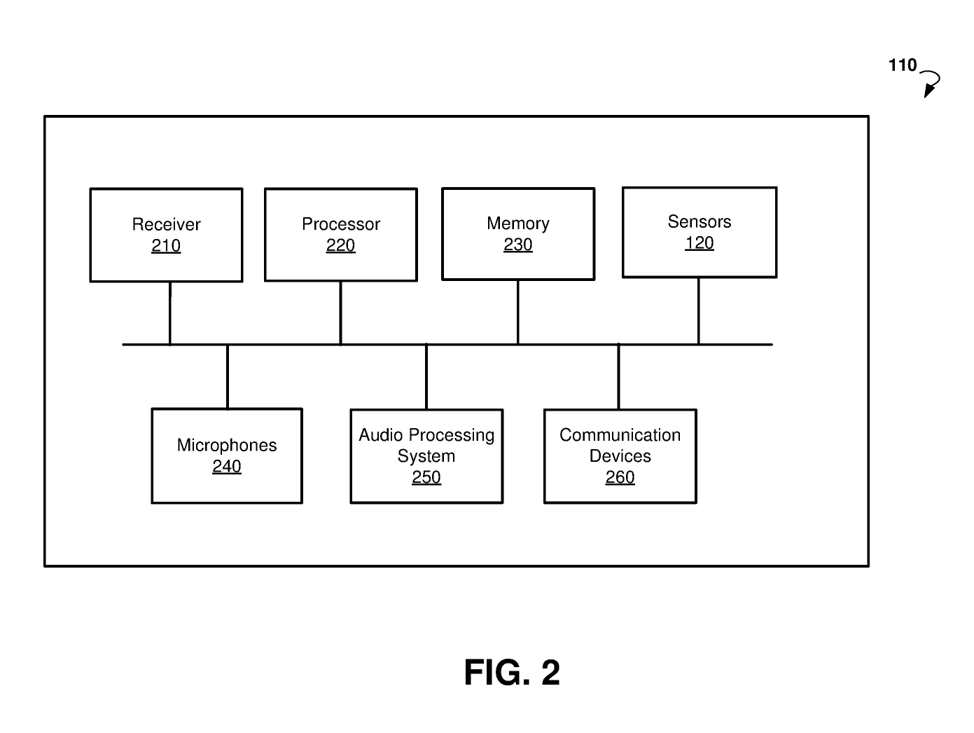

FIG. 2 is a block diagram showing components of an exemplary mobile device 110, according to an example embodiment. In the illustrated embodiment, the mobile device 110 includes at least a receiver 210, a processor 220, memory 230, sensors 120, microphones 240, an audio processing system 250, and communication devices 260. The mobile device 110 may also include additional or different components operable to support operations of mobile device 110. In other embodiments, the mobile device 110 can include fewer components that perform similar or equivalent functions to those depicted in FIG. 2.

The processor 220 can include hardware and/or software, which is operable to execute computer programs stored in a memory 230. The processor 220 can use floating point operations, complex operations, and other operations, including steps of the method for gesture recognition. In some embodiments, the processor 220 of the mobile device can include at least one of a digital signal processor, an image processor, an audio processor, a general-purpose processor, and the like.

The audio processing system 250 can be configured to receive acoustic signals representing sounds captured from acoustic sources via microphones 240 and process the acoustic signals components. The acoustic signals may be converted into e digital signals for processing by the audio processing system 250.

Communication devices 260 can include elements operable to communicate data between mobile devices 110 and computing cloud(s) 150 via a network. In various embodiments, the communication devices can include a Bluetooth element, an Infrared element, a Wi-Fi element, an NFC element, beacon element, and the like.

In some embodiments, the sensor data of a mobile device 110 (as shown in example in FIG. 1) can be transmitted to the processor 220 for processing, stored in the memory 230, and/or transmitted to a computing cloud 150 for further processing.

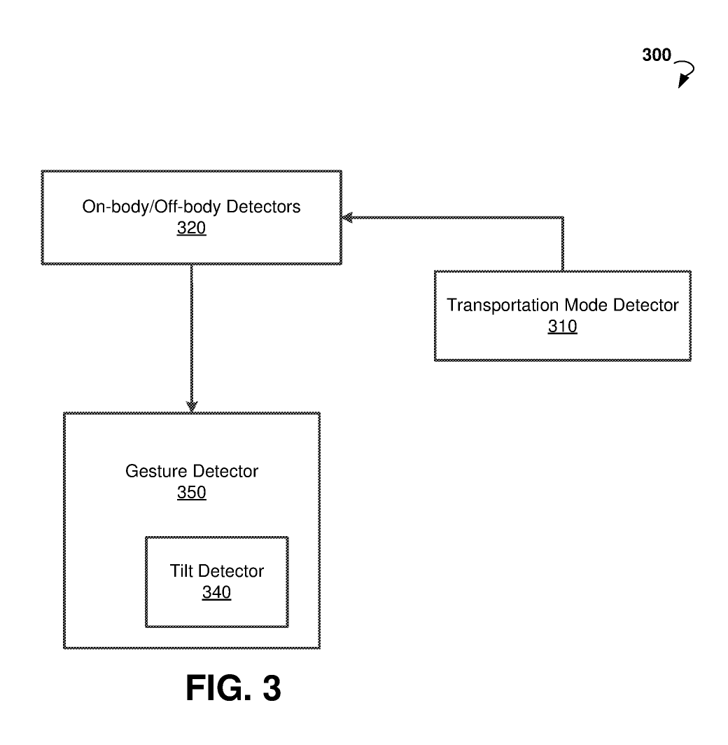

FIG. 3 is a block diagram illustrating an exemplary system 300 including various elements for a method for gesture recognition, according to an example embodiment. In some embodiments, the elements of system 300 are stored as instructions in memory 230 of the mobile device 110 to be executed by processor 220. The example system 300 may include the following: a transportation mode detector 310, on-body/off-body detectors 320 (also referred to as the on/off body detectors), and a gesture detector 350. The gesture detector 350 includes a tilt detector 340 in various embodiments.

In some embodiments, the transportation mode detector 310 is operable to analyze sensor data associated with a mobile device and determine a particular transportation mode associated with movements of the mobile device. In some embodiments, the analyzed sensor data include raw accelerometer data. In some embodiments, the transportation mode detector 310 analyzes sensor data from one or more microphones from which captured sounds that are unique to a moving vehicle (e.g., a car, train, or tram) can be used to identify the user's mode of transport. A combination of raw accelerometer data and captured sounds from an acoustic sensor may be used. GPS and Wi-Final/cell tower positioning can also be used for detecting the transport mode in some embodiments. In various embodiments, the transportation mode can be detected at a particular moment to be, for example, a rest state mode, or modes associated with movements of the mobile device when the user of the mobile device is walking, running, riding a bicycle, driving in a car or another transport vehicle.

In various embodiments, there is a separate on/off body detector associated with each of the transport modes as determined by transportation mode detector 310. Once the transportation mode is detected, a selection can be made of the one of the on/off body detectors that corresponds to the detected transportation mode (also referred to herein as the transport mode).

In some embodiments, classifiers for on/off body detector 320 are designed and trained separately for different transportation modes. The off-body detector or on-body detector associated with a particular transportation mode can be trained using test sensor data collected when mobile device is in a specific transportation mode. In various embodiments, the elements 310-330 include one or more state classifiers. The state classifiers can be implemented using various machine learning techniques such as, but not limited to, a neural network, a deep neural network, support vector machines, a hidden Markov models, and the like. The data used for training the classifier can include raw accelerometer data and features extracted from the raw accelerometer data, for example minimum and maximum acceleration, minimum and maximum speed, minimum and maximum shift or rotation, and so forth. In some embodiments, the classifier can be trained on one or more of raw accelerometer data, acoustic data from microphones, GPS positioning data, and Wi-Fi/cell tower positioning data.

In various embodiments, the on/off body detectors 320 can be operable to analyze movements associated with the mobile device 110 and determine probability of a state of the mobile device 110 associated with position of the mobile device 110 relative to the user body, for the transport mode that corresponds to the particular on/off body detector. The on/off body detector 320 can facilitate estimating a probability that the mobile device 110 is located on a user's body (i.e., on-body), for a corresponding transport mode. Similarly, an on/off body detector 320 can facilitate a probability that the mobile device 110 is located off the user's body (i.e., off-body), for example, on a table, in a trunk, and so forth. By way of example and not limitation, these detectors and methods for detecting and classifying states associated with mobile device, e.g., states such as off-body, on-body, etc., are described further in U.S. Utility patent application Ser. No. 14/321,707, entitled “Selecting Feature Types to Extract Based on Pre-Classification of Sensor Measurements,” filed Jul. 1, 2014, and in U.S. Utility patent application Ser. No. 14/090,966, entitled “Combining Monitoring Sensor Measurements and System Signals to Determine Device Context,” filed Nov. 26, 2013, which are incorporated herein by reference in their entireties.

In some embodiments, the gesture detector 350 includes a tilt detector 340 operable to determine a tilt angle associated with orientation of the mobile device relative to earth plane. In some embodiments, the gesture detector 350 is operable to receive sensor data, for example, raw accelerometer data. Based on the sensor data, the gesture detector 350 may also detect various energy changes associated with movement of the mobile device In some embodiments, outputs of the elements 310, 320 and 340 are utilized by the gesture detector 350.

In some embodiments, multiple microphones in a device can be combined to form a triaxial accelerometer, such that the pickup and glance gestures can be detected using raw data from the microphones.

As described in further detail below, the gesture detector 350 can be operable to recognize the pickup gesture and the glance gesture.

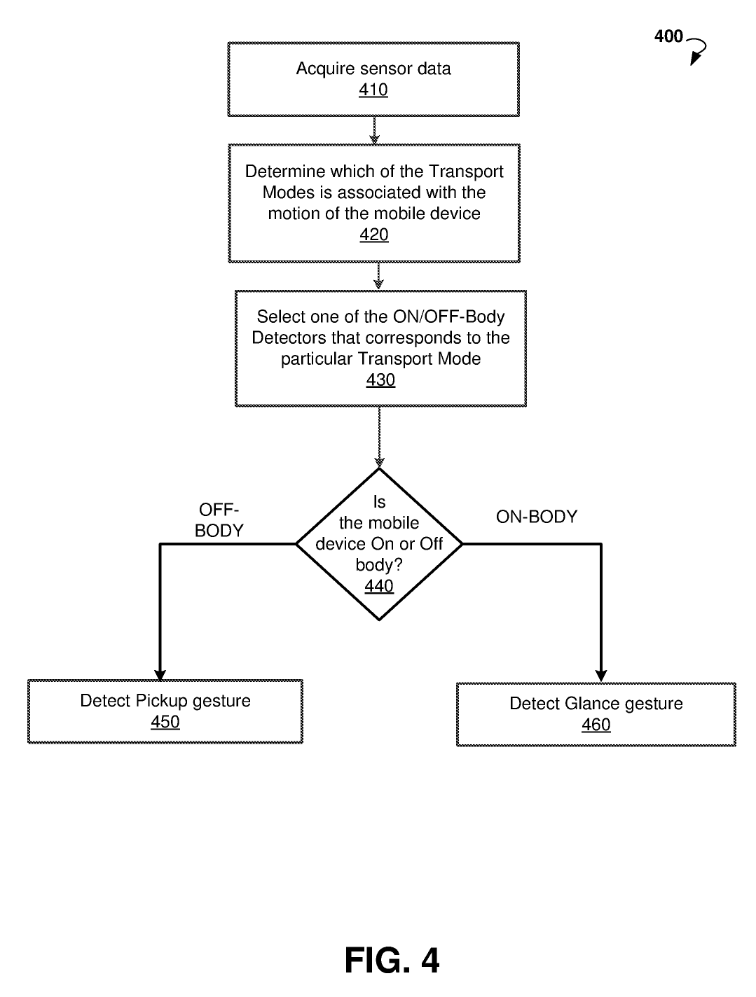

FIG. 4 is a block is a flow chart illustrating, at a high level, an example method for pickup and glance gesture recognition. In block 410, sensor data may be acquired. In block 420, based on the sensor data, the example method determines which of the transport modes is associated with the motion of the mobile device. In block 430, the example method includes selection of one of the on/off body detectors that corresponds to the particular determined transport mode. In block 440, the selected on/off body detector detects whether the mobile device is on or off body. If the mobile device is detected to be off the body of the mobile device user, the method may proceed, at block 450, to analyze the sensor data to detect the pickup gesture. On the other hand, if the mobile device is detected to be on the body of the mobile device user, the method may proceed, at block 60, to analyze the sensor data to detect the glance gesture.

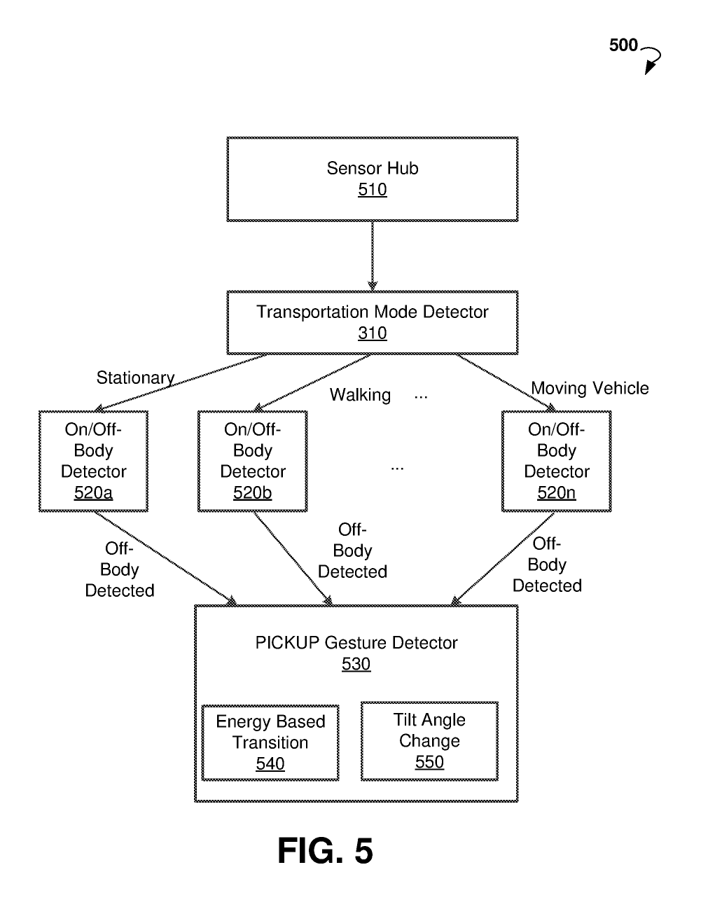

FIG. 5 is block diagram showing an exemplary system 500 including elements for a method for pickup gesture recognition, according to an example embodiment. The system 500 includes sensor hub 510, transportation mode detector 310 (also shown in FIG. 3), on/off body detectors 520a, 520b, . . . , and 520n. The exemplary system 500 further includes pickup gesture detector 530, which in turn, may include an energy based transition 540 and a tilt angle change 500 element.

Sensor hub 510, in various embodiments, is operable to provide a stream of sensor data associated with the mobile device. The sensor data may include one or more of raw accelerometer data, acoustic sensor data from microphone(s), GPS data, and Wi-Fi/cell tower positioning data. The stream of sensor data can be further analyzed by elements 310, 520a, 520b, . . . , and 520n, 530, 540, and 550 to determine whether a pickup gesture has occurred.

In some embodiments, the transportation mode detector 310 analyzes the sensor data to determine a transportation mode in which the mobile device is currently operated. By way of example and not limitation, the transportation mode can include a “stationary” mode, a “walking” mode, and a “moving vehicle” mode. The stationary mode can correspond to situations with the mobile device being kept at rest (e.g., static), for example, being lain down on a desk table in office. The walking mode can correspond to situations in which a user of the mobile device is walking. Similarly, the “moving vehicle” mode can correspond to cases in which the user of the mobile device is in a moving car or other moving vehicle.

In various embodiment, the sensor data can be further analyzed by a selected on/off body detector that is designed for a specific transportation mode determined by a transportation mode detector 310. In example of FIG. 5, the on/off body detector 520a is designed and trained to be used when the mobile device is operating in a stationary mode, the on/off body detector 520b is designed and trained to be used when the mobile device is operating in a walking mode, and the on/off body detector 520n is designed and trained to be used when the mobile device is in a moving vehicle. The on/off body detectors 520a, 520b, . . . , and 520n can be operable to determine whether the mobile device is located off the user's body. In some embodiments, the on/off body detectors estimate a probability of a state that the mobile device is located off the user's body, e.g., using machine learning on the sensor data, as described in further detail in U.S. Utility patent application Ser. Nos. 14/321,707 and 14/090,966, referenced above.

A particular on/off body detector may be selected based on the transport mode determined by the transportation mode detector 310. The output of the selected one of the on/off body detectors can be provided to pickup gesture detector 530. The pickup gesture detector 440 may have two detector elements including an energy based transition (detector) 540 and tilt angle change (detector) 550 (also referred to herein as the energy based transition detector 540 and tilt angle change detector 550). The energy based transition detector 540 and/or tilt angle change detector 550 may also be separate elements that provide their outputs to the pickup gesture detector 530.

In some embodiments, energy based transition detector 540 is operable to analyze sensor data and detect a change or a transition in energy associated with movements of the mobile device 110. The energy transition can depend on how fast the sensor data changes. In some embodiments, the sensor data is accelerometer data, such that the energy transition depends on how fast the accelerometer data changes. In some embodiments, the sensor data can include acoustic data where multiple microphones form a triaxial accelerometer, or a combination of accelerometer and acoustic data may be used.

In various embodiments, energy based transition detector 540 is operable to compare the energy change to an energy based threshold to distinguish energy transitions caused by a user pickup and energy transitions caused by an impact due to an environment in which the mobile device 110 is operated. For example, energy based transition detector 540 can be operable to discriminate, based on the energy based threshold, an energy transition caused by an actual user pickup and an energy transition caused by sudden stop of a moving vehicle at a traffic light or a sudden acceleration of the moving vehicle after the stop. In some embodiments, the energy based threshold can depend on a transportation mode determined by transportation mode detector 310. The energy transition being below the energy based threshold can be indicative of the energy transition caused by an actual user pick up. If, before the energy transition, the mobile device is off body, as determined by the selected on/off body detectors 520a, 520b, . . . , and 520n (corresponding to the transport mode), and the energy transition is above the energy based threshold, the mobile device has been likely picked up by a user. This indication can be used by the rest of pickup gesture detector 530.

In various embodiments, pickup gesture detector 530 may also utilize tilt angle change detector 550 to track a tilt angle of the mobile device with respect to an earth plane. For example, if the mobile device is off body (i.e., off-body) and the tilt angle is changed by at least a pre-determined angle value, it may indicate that the mobile device is picked by the user. In some embodiments, the predetermined angle value is about 5 degrees. In some embodiments, a pickup gesture is considered to be recognized, if before the tilt angle is changed, the mobile device is off body, an energy transition associated with the tilt angle change is above the energy based threshold, and a tilt angle is changed by at least a pre-determined angle value.

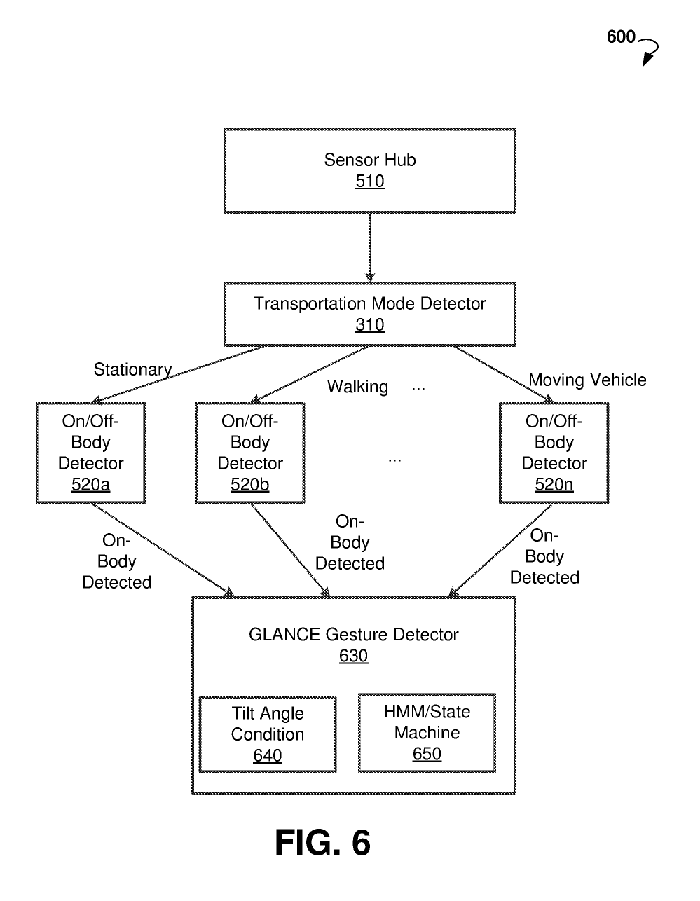

FIG. 6 is block diagram illustrates an exemplary system 600 including elements operable to execute a method for glance gesture recognition, according to an example embodiment. The system 600 can include a sensor hub 510 (also shown in FIG. 5), a transportation mode detector 310 (also shown in FIG. 4 and FIG. 5), and on/off body detectors 520a, 520b, . . . , and 520n (also shown in FIG. 5).

A particular on/off body detector may be selected based on the transport mode determined by the transportation mode detector 310. The output of the selected one of the on/off body detectors (i.e., that corresponds to the transport mode) can be provided to glance gesture detector 630. The glance gesture detector 630 may include a tilt angle condition (detector) 640 and a hidden Markov model (HMM)/state machine 650 (described in further detail below). In some embodiments, tilt angle condition 640 and an HMM/state machine 650 may also be separate elements that provide their outputs to the glance gesture detector 630.

The functionalities of the sensor hub 510 and transportation mode detector 310 in FIG. 6 are described further above with respect to FIG. 5.

In some embodiments, transportation mode detector 310 determines a transportation mode based on the sensor data. The sensor data may include one or more of raw accelerometer data, acoustic data from microphone(s), GPS positioning data, and Wi-Fi/cell tower positioning data. The sensor data is further analyzed by a specific on-body detector that is designed for the transportation mode. In various embodiments, the on/off body detectors 520a, 520b through 520n are as described above with respect to FIG. 5. In the example in FIG. 6, recognition of a glance gesture depends on having an indication, from the on/off body detectors 520a, 520b through 520n, that the mobile device is found on the user's body. In example of FIG. 6, the on/off body detectors 520a, 520b through 520n detect that the mobile device is on-body (i.e., “On-body detected), e.g., estimating a probability of a state that the mobile device is located on the user body.

In some embodiments, angle condition and HMM 530 is operable to analyze a change in raw accelerometer data and track a tilt angle of the mobile device relative to an earth plane. The accelerometer data can be from an accelerometer sensor or from a triaxial accelerometer formed by a combination of multiple microphones. In some embodiments, the glance gesture is recognized when the tilt angle is changed to be within a pre-defined (angle) range suitable for the user to glance at a screen of the mobile device.

In some embodiments, the angle condition and HMM 530 can include a state machine or a hidden Markov model (HMM) to determine whether the mobile device in a position where the user is able to glance at the screen. In certain embodiments, the state machine includes two states “Glance” and “No Glance”. The glance state can correspond to positions of the mobile device where the tilt angle of the mobile device is within the pre-determined range. The no glance state can correspond to orientations of the mobile device in which the tilt angle of the mobile device is outside the pre-determined range. In some embodiments, the screen of the mobile device turns on when mobile device in the glance state and turns off when the mobile device is in the no glance state. In some embodiments, transitions between states are determined based on a change of the tilt angle and a time constraint during which the change of the tilt angle remains. In some embodiments, a transition between the glance and glance states is considered to be completed if a changed value of the tilt angle remains for at least a pre-determined time period (e.g., a predetermined time constant). In certain embodiment, the pre-determined period is about 1 second. Using the time constraint for the transitions may prevent the change of states from the glance state to the no glance state due to accidental short changes in the tilt angle. This may prevent the screen of the mobile device from being accidently turned off and on. The accidental short changes of tilt angle can be caused by a hand tremor if the user has more than a normal trembling or a vehicle vibration and shakes due to road conditions. In further embodiments, the transitions between the states in the state machine can be conditioned by further constraints. In certain embodiments, the state machine can be custom designed based on requirements of the manufacturer of the mobile device, for example, varying the pre-determined period, etc.

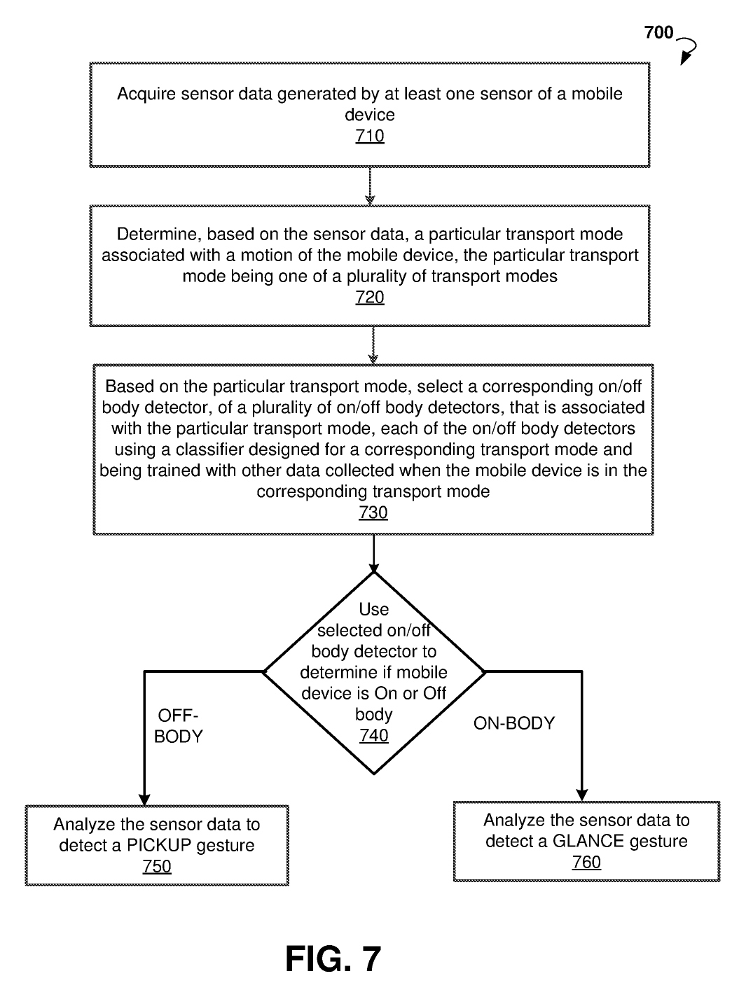

FIG. 7 is flow chart diagram showing steps of an exemplary method 700 for gesture recognition on a mobile device, according to various example embodiments. Method 700 may commence in block 710 with acquiring sensor data generated by at least one sensor of a mobile device. In some embodiments, the sensor data includes at least raw accelerometer data. In some embodiments, the sensor data includes acoustic data from microphone(s), GPS positioning data, and Wi-Fi/cell tower positioning data. In block 720, method 700 can proceed with determining, based on the sensor data, the particular transport mode that is associated with the motion of the mobile device. The particular transport mode can be one of a plurality of transport modes. Some transport modes are identified in FIGS. 5 and 6, e.g., stationary, walking, in moving vehicle (such as a bicycle, automobile, etc.).

In block 730, method 700 can make a selection, based on the particular transport mode, of a corresponding on/off body detector, of a plurality of on/off body detectors, that is associated with the particular transport mode. Each of the on/off body detectors may use a classifier that is designed for a corresponding transport mode and trained with other data collected when the mobile device is in the corresponding transport mode, as further described herein.

In block 740 of the example method in FIG. 7, the selected on/off body detector is used to determine if the mobile device is on-body or off-body. If the mobile device is determined, by the selected on/off body detector, to be off-body, then, in block 750, the sensor data is analyzed to detect a pickup gesture, as described further herein at least regarding FIG. 5. On the other hand, if the selected on/off body detector determines that the mobile device is on-body, then, in block 760, the sensor data is analyzed to detect a glance gesture, as further detailed herein at least regarding FIG. 6.

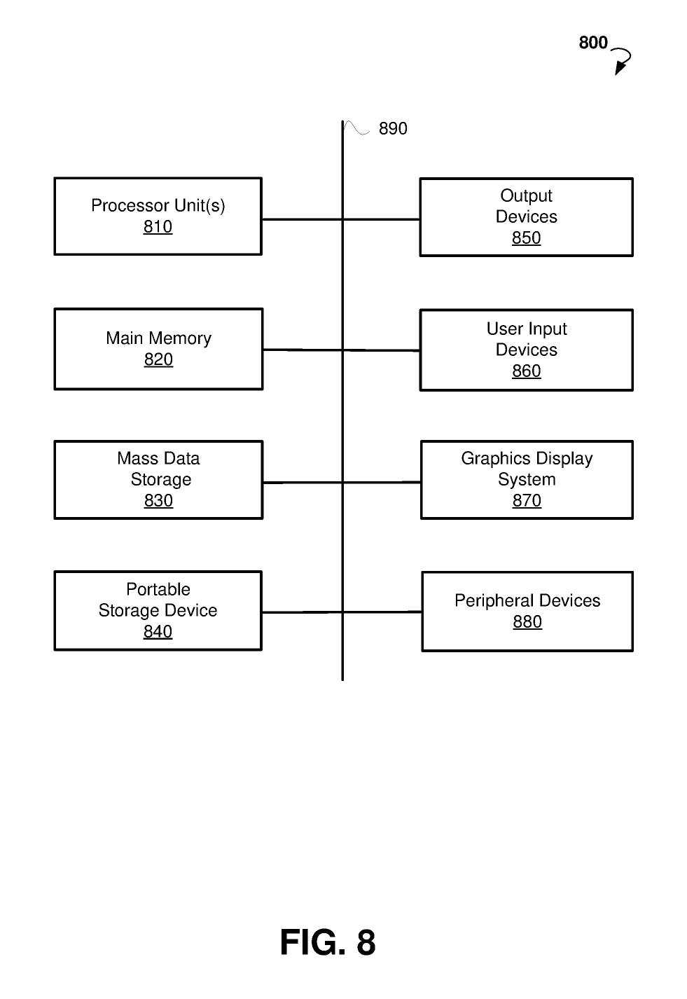

FIG. 8 illustrates an exemplary computer system 800 that may be used to implement some embodiments of the present invention. The computer system 800 of FIG. 8 may be implemented in the contexts of the likes of computing systems, networks, servers, or combinations thereof. The computer system 800 of FIG. 8 includes one or more processor unit(s) 710 and main memory 820. Main memory 820 stores, in part, instructions and data for execution by processor unit(s) 810. Main memory 820 stores the executable code when in operation, in this example. The computer system 800 of FIG. 8 further includes a mass data storage 830, portable storage device 840, output devices 850, user input devices 860, a graphics display system 870, and peripheral devices 880.

The components shown in FIG. 8 are depicted as being connected via a single bus 890. The components may be connected through one or more data transport means. Processor unit(s) 810 and main memory 820 is connected via a local microprocessor bus, and the mass data storage 830, peripheral devices 880, portable storage device 840, and graphics display system 870 are connected via one or more input/output (I/O) buses.

Mass data storage 830, which can be implemented with a magnetic disk drive, solid state drive, or an optical disk drive, is a non-volatile storage device for storing data and instructions for use by processor unit(s) 810. Mass data storage 830 stores the system software for implementing embodiments of the present disclosure for purposes of loading that software into main memory 820.

Portable storage device 840 operates in conjunction with a portable non-volatile storage medium, such as a flash drive, floppy disk, compact disk, digital video disc, or Universal Serial Bus (USB) storage device, to input and output data and code to and from the computer system 800 of FIG. 8. The system software for implementing embodiments of the present disclosure is stored on such a portable medium and input to the computer system 800 via the portable storage device 840.

User input devices 860 can provide a portion of a user interface. User input devices 860 may include one or more microphones, an alphanumeric keypad, such as a keyboard, for inputting alphanumeric and other information, or a pointing device, such as a mouse, a trackball, stylus, or cursor direction keys. User input devices 860 can also include a touchscreen. Additionally, the computer system 800 as shown in FIG. 8 includes output devices 850. Suitable output devices 850 include speakers, printers, network interfaces, and monitors.

Graphics display system 870 include a liquid crystal display (LCD) or other suitable display device. Graphics display system 870 is configurable to receive textual and graphical information and processes the information for output to the display device.

Peripheral devices 880 may include any type of computer support device to add additional functionality to the computer system.

The components provided in the computer system 800 of FIG. 8 are those typically found in computer systems that may be suitable for use with embodiments of the present disclosure and are intended to represent a broad category of such computer components that are well known in the art. Thus, the computer system 800 of FIG. 8 can be a personal computer (PC), hand held computer system, telephone, mobile computer system, workstation, tablet, phablet, all-in-one, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 800 is implemented as a cloud-based computing environment, such as a virtual machine operating within a computing cloud. In other embodiments, the computer system 800 may itself include a cloud-based computing environment, where the functionalities of the computer system 800 are executed in a distributed fashion. Thus, the computer system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 800, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for gesture recognition, the method comprising:
acquiring sensor data generated by at least one sensor of a mobile device;
determining, based on the sensor data, a particular transport mode associated with a motion of the mobile device, the particular transport mode being one of a plurality of transport modes;
based on the particular transport mode, selecting a corresponding on/off body detector, of a plurality of on/off body detectors, that is associated with the particular transport mode, each of the on/off body detectors using a classifier designed for a corresponding transport mode and being trained with other data collected when the mobile device is in the corresponding transport mode;
using the selected on/off body detector to determine if the mobile device is located on the body of a user or off the body of the user;
if the mobile device is determined to be on the body of the user, analyzing the sensor data to detect a glance gesture; and
if the mobile device is determined to be off the body of the user, analyzing the sensor data to detect a pickup gesture.

2. The method of claim 1, wherein the sensor data includes raw accelerometer data.

3. The method of claim 2, wherein the sensor data also include acoustic data from one or more microphones.

4. The method of claim 1, wherein the sensor data includes one or more of acoustic data from one or more microphones, GPS data, Wi-Fi data, and cell tower data.

5. The method of claim 1, wherein the plurality of transport modes include at least two of the following: a first transport mode in which the mobile device is at rest, a second transport mode in which the mobile device is moving along with the user of the mobile device as the user is walking, and a third transport mode in which the mobile device is located in a moving vehicle.

6. The method of claim 1, wherein the analyzing the sensor data to recognize the pickup gesture includes:
calculating, based on the sensor data, an energy change associated with the motion of the mobile device; and
determining that the energy change is less than a pre-defined energy threshold.

7. The method of claim 6, wherein the analyzing the sensor data to recognize the pickup gesture further includes:
calculating, based on the sensor data, a tilt angle change associated with the motion of the mobile device; and
determining that the tilt angle change exceeds a pre-determined angle threshold.

8. The method of claim 1, wherein the analyzing the sensor data to recognize the glance gesture is performed based on an output of a state machine, the state machine including a first state and a second state, the first state being associated with values of a mobile device tilt angle within a pre-determined range, and the second state being associated with the values of the mobile device tilt angle outside the pre-determined range.

9. The method of claim 8, wherein a transition between the first state and the second state is determined based on the following conditions:
the mobile device tilt angle is moved from within the pre-determined range to outside the pre-determined range; and
the mobile device tilt angle remains outside the pre-determined range for at least a pre-determined time constant.

10. The method of claim 9, wherein the pre-determined time constant is about 1 second.

11. The method of claim 1, wherein the sensor comprises a plurality of microphones forming a triaxial accelerometer.

12. A system for gesture recognition, the system comprising:
a processor;
a memory communicatively coupled to the processor;
at least one sensor;
the processor configured for acquiring sensor data generated by the at least one sensor of a mobile device;
a transport mode detector configured for determining, based on the sensor data, a particular transport mode associated with a motion of the mobile device, the particular transport mode being one of a plurality of transport modes;
a plurality of on/off body detectors, each of the plurality of on/off body detectors using a classifier designed for a corresponding transport mode and being trained with other data collected when the mobile device is in the corresponding transport mode;
the processor further configured for, based on the particular transport mode, selecting a corresponding one of the plurality of on/off body detectors that is associated with the particular transport mode;
the processor further configured for using the selected on/off body detector to determine if the mobile device is located on the body of a user or off the body of the user;
a glance gesture detector configured for, if the mobile device is determined to be on the body of the user, analyzing the sensor data to detect a glance gesture; and
a pickup gesture detector configured for, if the mobile device is determined to be off the body of the user, analyzing the sensor data to detect a pickup gesture.

13. The system of claim 12, wherein the sensor data includes raw accelerometer data.

14. The system of claim 12, wherein the sensor data includes one or more of acoustic data from one or more microphones, GPS data, Wi-Fi data, and cell tower data.

15. The system of claim 12, wherein the plurality of transport modes include at least two of the following: a first transport mode in which the mobile device is at rest, a second transport mode in which the mobile device is moving along with the user of the mobile device as the user is walking, and a third transport mode in which the mobile device is located in a moving vehicle.

16. The system of claim 12, wherein the gesture detector, for analyzing the sensor data to detect the pickup gesture, is configured to calculate, based on the sensor data, an energy change associated with the motion of the mobile device, and to determine that the energy change is less than a pre-defined energy threshold.

17. The system of claim 16, wherein the gesture detector is further configured to calculate, based on the sensor data, a tilt angle change associated with the motion of the mobile device, and to determine that the tilt angle change exceeds a pre-determined angle threshold.

18. The system of claim 12, wherein the gesture detector, for analyzing the sensor data to detect the glance gesture, is configured to use the output of a state machine, the state machine including a first state and a second state, the first state being associated with values of a mobile device tilt angle within a pre-determined range, and the second state being associated with the values of the mobile device tilt angle outside the pre-determined range.

19. The system of claim 18, wherein a transition between the first state and the second state is determined based on the following conditions:
the mobile device tilt angle is moved from within the pre-determined range to outside the pre-determined range; and
the mobile device tilt angle remains outside the pre-determined range for at least a pre-determined time constant.

20. A non-transitory computer-readable storage medium having embodied thereon instructions, which, if executed by one or more processors, perform a method for gesture recognition, the method comprising:
determining, based on sensor data, a particular transport mode associated with a motion of a mobile device, the particular transport mode being one of a plurality of transport modes, the sensor data generated by at least one sensor of the mobile device;
based on the particular transport mode, selecting an on/off body detector, of a plurality of on/off body detectors, that is associated with the particular transport mode, each of the on/off body detector using a classifier designed for a corresponding transport mode and being trained with other data collected when the mobile device is in the corresponding transport mode;
using the selected on/off body detector to determine if the mobile device is located on the body of a user or off the body of the user;
if the mobile device is determined to be on the body of the user, analyzing the sensor data to detect a glance gesture; and
if the mobile device is determined to be off the body of the user, analyzing the sensor data to detect a pickup gesture.
